(19) United States
(12) Patent Application Publication
(10) Pub. No.: US 2014/0061119 A1
(43) Pub. Date: Mar. 6, 2014

(54) End Disk for a Filter Element

(71) Applicant: MANN+HUMMEL GMBH, Ludwigsburg (DE)

(72) Inventors: Horst Croissant, Hochstadt (DE); Michael Wolf, Neunkirchen (DE)

(73) Assignee: MANN+HUMMEL GMBH, Ludwigsburg (DE)

(21) Appl. No.: 14/069,412

(22) Filed: Nov. 1, 2013

Related U.S. Application Data
(63) Continuation of application No. PCT/EP2012/058045, filed on May 2, 2012.

(30) Foreign Application Priority Data
May 3, 2011 (DE) 10 2011 100 352.9

(51) Int. Cl. B01D 35/30

(52) U.S. Cl. CPC B01D 35/30
USPC 210/444; 210/541

(57) ABSTRACT

A plastic end disk for a filter element has a disk-shaped-section sealing an end face of a star-pleated bellows and has a hollow-cylindrical section extending away from the disk-shaped-section. An inner side of the hollow-cylindrical section radially seals the plastic end disk on a receiving pin by an O-ring. The hollow-cylindrical section has noses arranged on the inner side that extend into the interior the hollow-cylindrical section. The noses house an O-ring. The noses include first noses extending in a first plane parallel to the disk-shaped-section and second noses extending in a second plane that is spaced apart from the first plane in axial direction. The first noses are displaced relative to the second noses such that the first noses, when projected axially onto the second plane, and the second noses do not overlap and an undercut-free configuration of the plastic end disk is provided.

### CROSS-REFERENCE TO RELATED APPLICATIONS

This application is a continuation application of international application No. PCT/EP2012/058045 having an international filing date of May 2, 2012 and designating the United States, the International Application claiming a priority date of May 3, 2011, based on prior filed German patent application No. 10 2011 100 352.9, the entire contents of the aforesaid international application and the aforesaid German patent application being incorporated herein by reference.

### BACKGROUND OF THE INVENTION

The invention concerns a spin-on filter, a filter element, in particular for a spin-on filter, as well as an end disk for a filter element, in particular for filtration of fuel or oil.

For exchangeable use in a filter system, individual filter elements with a plastic end disk that houses an O-ring are disclosed, for example, in FIG. 1 of WO 2005/099861 A1. Plastic end discs are moreover known that, for ease of manufacture, are of a two-part configuration for housing an O-ring; see DE 20 2004 006 545 U1, for example.

The object of the invention is to provide a spin-on filter with a plastic end disk with an O-ring housed therein; a plastic end disk that can be more easily manufactured; a filter element with such a plastic end disk; and a spin-on filter with such a plastic end disk.

### SUMMARY OF THE INVENTION

In accordance with the present invention, this is achieved by a plastic end disk for a filter element that comprises a disk-shaped section for end-face sealing of a star-pleated bellows, a hollow-cylindrical section which is extending perpendicularly to the disk-shaped section in a first direction, wherein the inner side of the hollow-cylindrical section is embodied for radial sealing of the plastic end disk on a receiving pin by means of an O-ring, and wherein on the inner side of the hollow-cylindrical section noses that extend radially into the hollow-cylindrical section are provided for housing an O-ring. At least two noses are located on a first plane that is parallel to the disk-shaped section and at least two noses are located on a second plane spaced apart from the first plane in axial direction of the hollow-cylindrical section. The noses of the first plane are displaced or offset relative to the noses of the second plane such that the noses of the first plane, when projected axially onto the second plane, and the noses of the second plane do not overlap in order to enable an undercut-free configuration of the plastic end disk.

The object is further solved by a filter element comprising a star-pleated bellows and an end disk according to the invention as disclosed above.

The object is further solved by a spin-on filter comprising a threaded plate for attachment of the spin-on filter on a filter head, a metallic outer wall that is crimped with a seal support in such a way that the threaded plate is non-detachably connected to the outer wall, and a filter element, in particular a filter element according to the invention as disclosed above, with a star-pleated bellows with a plastic end disk that is oriented toward the threaded plate, in particular a plastic end disk according to the invention as disclosed above, wherein the plastic end disk houses an O-ring.

The plastic end disk according to the invention for a filter element comprises preferably a disk-shaped section for end-face sealing of a star-pleated bellows and a hollow-cylindrical section that extends perpendicularly to the disk-shaped section in a first direction.

Preferably, the inner side of the hollow-cylindrical section is embodied for providing a radial sealing action of the plastic end disk on a receiving pin by means of an O-ring wherein on the inner side of the hollow-cylindrical section noses are provided that extend radially into the interior of the hollow-cylindrical section and are designed for housing an O-ring. In this context, at least two noses extend within a first plane which is parallel to the disk-shaped-section and at least two noses extend within a second plane which is spaced relative to the first plane in the axial direction of the hollow-cylindrical section. The first and second planes and the noses arranged therein, respectively, are preferably axially spaced from each other such that between the first and second planes an O-ring can be received.

The first noses of the first plane are in particular displaced relative to the second noses of the second plane in the circumferential direction such that the first noses of the first plane, when projected axially onto the second plane, and the second noses of the second plane will not overlap.

In this way, the end disk can be produced in a simple way by injection molding.

The first noses of the first plane are thus in particular in circumferential direction arranged in different circular ring segments than the second noses of the second plane. Each nose of the first plane is thus positioned in particular in a circular ring segment in which the second plane has no noses.

In other words, it is preferred that first noses in the first plane are arranged in the circumferential direction at locations where a gap between two second noses of the second plane is present, and vice versa.

In a preferred embodiment, viewed in the circumferential direction, a first nose arranged in a first circular ring segment in the first plane follows circumferentially a second nose in the second plane arranged in a second circular ring segment that immediately adjoins the first circular ring segment.

In a particularly preferred embodiment, at least in partial sections of the circumference, or in particular about the entire circumference, a first nose in the first plane follows in this way a second nose in the second plane, respectively, and vice versa.

In a preferred embodiment, the first noses of the first plane, when projected onto the second plane, and the second noses of the second plane together form a circular ring. In this way, an O-ring can be supported and held axially in the best possible way between the noses of the two planes.

In a preferred embodiment, at least five first noses in the first plane and at least five second noses in the second plane are provided so that the O-ring is uniformly housed between the first and second noses.

In a preferred embodiment, the first noses of the first plane have the same shape as the second noses of the second plane.

In a preferred embodiment, the first noses of the first plane have a different shape than the second noses of the second plane.

In a preferred embodiment, the plastic end disk has a support section which extends in a direction opposite to the direction of extension of the hollow-cylindrical section.

In a preferred embodiment, the plastic end disk is of a monolithic configuration.

In a preferred embodiment, an O-ring for sealing relative to a receiving pin is arranged between the first noses of the first plane and the second noses of the second plane.

The invention concerns moreover a filter element comprising a star-pleated bellows as well as a plastic end disk according to the invention.

The invention concerns moreover a spin-on filter, comprising a threaded plate for attachment of the spin-on filter on a filter head, a metallic outer wall, and a seal support wherein the outer wall is crimped with the seal support in such a way that the threaded plate is non-detachably connected with the outer wall. The spin-on filter also comprises a filter element, in particular comprising a star-pleated bellows, with a plastic end disk according to the invention that is facing the threaded plate and that houses an O-ring.

In one embodiment, the threaded plate has a central passage with an inner thread which forms in particular a clean-side outlet for the filtered fluid and several non-central passages through which the fluid to be filtered can flow in and out of the spin-on filter.

Fluidically, between the central passage and the non-central passages a filter element is provided so that through the central passage liquid, for example, fuel or oil, can flow to the filter element, can pass through the filter element, and can exit through the non-central passages from the spin-on filter. The reverse flow direction is also possible.

The spin-on filter has in one embodiment a metallic outer wall that is crimped with a seal support in such a way that the threaded plate is non-detachably connected to the outer wall. On the seal support, there is preferably a seal, for example, an O-ring or a seal with a rectangular cross-section, that serves to seal the spin-on filter relative to the environment, particularly in axial direction, when the filter is screwed onto the filter head.

The filter element is particularly comprised of a star-pleated bellows with a plastic end disk which is facing the threaded plate. The end disk houses preferably an O-ring between the first noses of the first plane and the second noses of the second plane.

In one embodiment, the plastic end disk of the filter element contacts the threaded plate and is forced by means of a spring provided in the spin-on filter against the threaded plate.

In a preferred embodiment, the inner side of the hollow-cylindrical section is embodied for radial sealing of the plastic end disk by means of an O-ring relative to a receiving pin of the filter head, or a similar means. Upon installation of the spin-on filter, this receiving pin can penetrate or project into the spin-on filter.

In a preferred embodiment, the sealing action at the receiving pin in the spin-on filter can separate the raw side and the clean side of the filter element from each other.

Due to the separation by means of the O-ring, the contact of the filter element with the plastic end disk on the threaded plate, as provided in a further preferred embodiment, can be designed to be non-sealing and, for example, must not be glued.

### BRIEF DESCRIPTION OF THE DRAWING

FIG. 1 shows a spin-on filter with a filter element.

FIG. 2 shows an end disk of the filter element.

FIG. 3 shows a section view of the end disk of FIG. 2.

### DESCRIPTION OF THE PREFERRED EMBODIMENTS

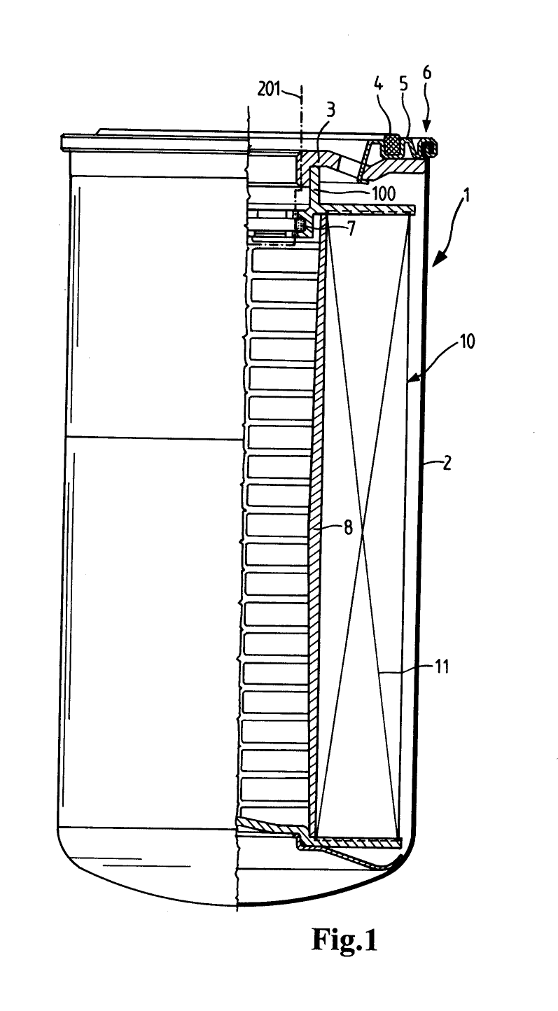

FIG. 1 shows a spin-on filter 1 with a threaded plate 3 for attachment of the spin-on filter 1 on a filter head. The threaded plate 3 has a central passage with an inner thread. Moreover, the threaded plate 3 has several non-central passages. Fluidically, between the central passage and the non-central passages a filter element 10 is provided so that through the central passage liquid, for example, fuel or oil, can flow to the filter element 10, can pass through the filter element 10, and can then exit or flow through the non-central passages out of the spin-on filter. The reverse flow direction is also possible. The spin-on filter has a metallic outer wall 2 which is crimped with a seal support 5 in such a way that the threaded plate 3 is non-detachably connected to the outer wall 2. On the seal support 5 a seal 4, for example, an O-ring or a seal of rectangular cross-section, is provided that serves for sealing the spin-on filter relative to the environment when the spin-on filter is screwed onto the filter head. The filter element 10 is configured with a star-pleated bellows 11 and with a plastic end disk 100 which is facing the threaded plate 3. The end disk houses an O-ring 7. The filter element 10 contacts with the plastic end disk 100 the threaded plate 3 and is pressed by means of a spring provided in the spin-on filter 1 against the threaded plate 3.

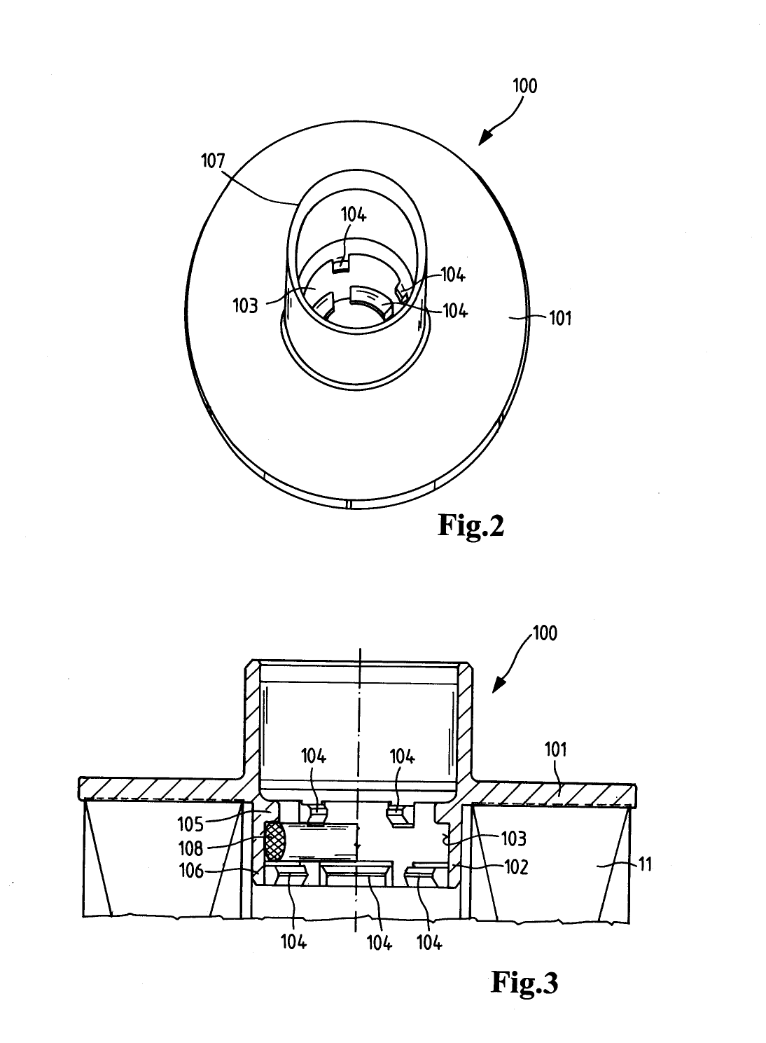

FIGS. 2 and 3 show a preferred plastic end disk of the spin-on filter of FIG. 1 in detail and in section view, respectively. The plastic end disk 100 comprises a disk-shaped-section 101 for end-face sealing of a star-pleated bellows 11. A hollow-cylindrical section 102 extends perpendicular to the disk-shaped-section 101 away from it. A support section 107 extends in a direction opposite to the extension of the section 102 away from the disk-shaped section 101.

The inner side 103 of the hollow-cylindrical section 102 is embodied for radial sealing of the plastic end disk 100 on a receiving pin 201 (pin 201 is schematically indicated in dash-dotted line in FIG. 1) by means of an O-ring 108. When installing the spin-on filter 1, this receiving pin 201 penetrates or projects into the spin-on filter. By the sealing action of the O-ring 108 at the receiving pin 201, the raw side and the clean side of the filter element 10 are separated from each other within the spin-on filter. Because of the separation by means of the O-ring 108, the contact of the filter element with its plastic end disk 100 at the threaded plate 3 can be designed so as to be non-sealing and requires no gluing action, for example.

On the inner side 103 of the hollow-cylindrical section 102, first and second noses 104 extend radially into the interior of the hollow-cylindrical section 102 and are designed for housing the O-ring 108. At least two noses 104 (first noses) are arranged in a first plane 105 that is parallel to the disk-shaped section 101 and at least two noses 104 (second noses) are arranged in a second plane 106 which is spaced relative to the first plane 105 in axial direction of the hollow-cylindrical section 102. The first noses 104 of the first plane 105 are displaced relative to the second noses 104 of the second plane 106 such that the first noses 104 of the first plane 105, when projected axially onto the second plane 106, will not overlap the second noses 104 of the second plane 106. In this way, an undercut-free configuration of the plastic end disk 100 is enabled so that the plastic end disk 100 can be produced easily by an injection molding process.

While specific embodiments of the invention have been shown and described in detail to illustrate the inventive principles, it will be understood that the invention may be embodied otherwise without departing from such principles.

What is claimed is:

1. A plastic end disk for a filter element, comprising:
a disk-shaped-section for end-face sealing of a star-pleated bellows,
a hollow-cylindrical section connected to the disk-shaped section and extending perpendicularly away from the disk-shaped-section;
wherein the hollow-cylindrical section comprises noses arranged on the inner side and extending radially into an interior the hollow-cylindrical section, wherein the noses are adapted to house an O-ring for radial sealing of the plastic end disk on a receiving pin;
the noses include at least two first noses extending in a first plane which is parallel to the disk-shaped-section and at least two second noses extending in a second plane that is spaced apart from the first plane in an axial direction of the hollow-cylindrical section;
wherein the at least two first noses are displaced relative to the at least two second noses such that the at least two first noses, when projected axially onto the second plane, and the at least two second noses do not overlap and an undercut-free configuration of the plastic end disk is provided.

2. The plastic end disk according to claim 1, wherein the at least two first noses, when projected onto the second plane, and the at least two second noses together define a circular ring.

3. The plastic end disk according to claim 1, wherein at least five of the first noses and at least five of the second noses are provided for uniformly housing the O-ring.

4. The plastic end disk according to claim 1, wherein the at least two first noses and the at least two second noses have the same shape.

5. The plastic end disk according to claim 1, wherein the at least two first noses have a shape that is different from a shape of the at least two second noses.

6. The plastic end disk according to claim 1, further comprising a support section connected to the disk-shaped-section and extending away from the disk-shaped section in a direction opposite to the hollow-cylindrical section.

7. The plastic end disk according to claim 1, wherein the plastic end disk is monolithic.

8. The plastic end disk according to claim 1, wherein an O-ring for sealing relative to a receiving pin is arranged between the at least two first noses and the at least two second noses.

9. A filter element comprising a plastic end disk according to claim 1 and a star-pleated bellows, wherein the plastic end disk is connected to the star-pleated bellows.

10. A spin-on filter comprising:
a threaded plate for attachment of the spin-on filter on a filter head;
a seal support arranged on the threaded plate;
a metallic outer wall that is crimped to the seal support such that the threaded plate is non-detachably connected to the outer wall;
a filter element arranged inside the outer wall and comprising a star-pleated filter bellows and a plastic end disk according to claim 1, wherein the plastic end disk is connected to the star-pleated bellows, faces the threaded plate, and houses an O-ring.
